(19) United States
(12) Patent Application Publication
(10) Pub. No.: US 2004/0151184 A1
(43) Pub. Date: Aug. 5, 2004

(54) Class-based rate control using multi-threshold leaky bucket

(75) Inventors: Linghsiao Wang, Irvine, CA (US); Craig Barrack, Irvine, CA (US)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor V.N. Inc., Irvine, CA (US)

(21) Appl. No.: 10/729,804

(22) Filed: Dec. 5, 2003

Related U.S. Application Data
(60) Provisional application No. 60/433,224, filed on Dec. 13, 2002.

(51) Int. Cl. H04L 12/56

(52) U.S. Cl. 370/395.2; 370/230

(57) ABSTRACT

Apparatus and methods of providing rate control at a user access point of an edge network node of a packet switched communications network are described. Rate control mechanisms are presented in respect of both ingress and egress rate control with quality of service support. Multiple thresholds associated with a single leaky bucket per traffic flow direction enable the mechanism to selectively control traffic rates based on a traffic class priority criteria.

### FIELD OF THE INVENTION

The invention relates to traffic management in packet-switched communications networks, and in particular to controlling traffic conveyance rates at an edge of a communication network.

### BACKGROUND OF THE INVENTION

Content traffic rate control is a mechanism applied at a user access point (102), at the edge of a service provider's packet-switched communications network 100, as exemplary shown in FIG. 1. An edge communications network node 102, typically provides up-link content traffic aggregation and content distribution as down-link content traffic. Therefore the content traffic rate control mechanism relates to two types of rate control.

In respect of content distribution, egress rate control restricts the total down-link traffic exiting the edge network node 102 via an output port 104 associated with the user 106. A communications network access device 108 associated with the user 106 and connected to the output port 104, may not be able to process an arbitrarily long burst of content received at wire-speed from the edge network node 102 for a variety of reasons including, but not limited to: the network access device 108 having only a small packet receive cache, the network access device 108 being only capable of performing packet classification at a low rate, the network access device 108 having a limited memory access bandwidth, etc. Depending on the particular deployment and services supported, the network access device 108 may also need to perform highly complex packet processing such as, but not limited to: content encryption/decryption, protocol-specific operations on voice and/or video, accounting, etc., which further deplete resources at the network access device 108 and incur delays in processing content. Typically the processing benchmark for such a network access device 108 is the number of content flows supported as opposed to whether packets are processed at wire-speed.

Certainly, ingress rate control can be performed at the network access device 108 as a substitute for egress rate control at the edge network node 102, seemingly with a similar effect. There are some differences particularly in applying ingress rate control wherein the network access device 108 may have no choice but to drop incoming packets which cannot be handled as resources are depleted at the network access device 108. Therefore, some form of egress rate control at the edge network node 102 will typically be required for such deployments in order to prevent overloading the network access device 108. Egress rate control at the edge network node 102 may be preferable, particularly if the edge network node 102 has large content buffering resources to survive long content bursts without experiencing congestion and therefore reducing packet discard in the long term.

In respect of content aggregation, ingress rate control restricts the amount of up-link traffic entering the edge network node 102 from a given input port 110 associated with the user 106. In view of the above, ingress rate control is a desirable feature at the edge network node 102, even if, as was usually the case in the year 2002, a Layer 2 edge network node 102, such as, but not limited to, a Digital Subscriber Line Aggregation Module (DSLAM), has sufficient content buffering resources to handle incoming up-link traffic at wire-speed on all input ports 110 indefinitely.

In respect of deployments where each port 104/110 is assigned to a single user 106, it may be desired to limit the down-link/up-link traffic conveyed via each port 104/110 independent of other ports 104/110, and independent of the true maximum content conveyance speed of the port 104/110 and capabilities of the network access device 108. The service provider can then offer different levels of service based on distinct negotiated down-link and up-link bandwidth apportionments for each user 106. Ingress/egress rate control parameters at the edge network node 102 must be configurable per port 104/110 in order to provide differing levels of service.

Current known implementations of both ingress and egress rate control apply a well-known technique called leaky bucket regulation. Leaky bucket regulation employs a simple algorithm with two parameters “b” and “r”. The first parameter b represents the bucket size in available tokens (typically corresponding to available storage resources). A parameter “R” represents the actual token depletion rate such that: tokens representative of tracked conveyed content are said to be removed from the bucket at rate R, up to a maximum number of tokens b. Tokens are representative of conveyed content payload units such as, but not limited to: bits, bytes, words, fixed size frames, etc. Tokens hereinafter will be understood to represent bytes stored in a port buffer 112/114 without loss of generality. Tokens are returned to the bucket at a rate “r” (the second leaky bucket parameter) representative of the rate at which content is being processed therethrough.

Tokens are removed. from and added to the bucket in token groups representative of the size of corresponding packets conveyed. Each content packet arrival, when it occurs, therefore requires a predetermined number of tokens n to be removed from the bucket as storage space at the edge network node 102 is being used up. If there is storage space at the edge network node 102, and therefore if there are at least n tokens in the bucket, then n tokens are removed from the bucket, and no further action is taken. But if there is insufficient storage space at the edge network node 102, and therefore n tokens are not available in the bucket when the corresponding packet arrives, a regulatory action is performed instead.

Setting r equal to a desired regulated rate, such as a negotiated service rate, then it follows that regulatory action will be taken if and only if the unregulated content conveyance rate R, during some time interval, exceeds the regulated negotiate service rate r. With respect to ingress rate control, each packet received from the network access device 108 removes tokens from a bucket tracking input buffer 114 occupancy, and the regulatory action can either be packet discard or the initiation of flow control on that input port 110. With respect to egress rate control, each packet transmission from the corresponding output buffer 112 of the output port 104 adds tokens to the bucket tracking output buffer 112 occupancy whenever the down-link is idle and at least one packet is queued for transmission in the output port buffer 1 12. In respect of egress rate control, assuming ample storage resources at the edge network node 102, it is desirable that packets, which have traversed the entire communications network infrastructure from the remote source network node, not be discarded so close to the destination network node 106 so as not to incur a large content transport overhead.

The above described classic leaky bucket rate regulation presents at least two problems. Let R be the wire-speed associated with the up-link, and therefore with the input port 110. When a burst of packets of size L>>b arrives at the input port 110, the ingress leaky bucket will soon begin to drop a ratio 1-r/R of the incoming packets during the burst. Because the up-link negotiated (regulated) rate r may be much less than R—by a factor of 10 or more—over 90% of the packets may be dropped during such a burst. If these packets are constituent of a Transport Control Protocol over Internet Protocol (TCP/IP) data session, the sudden lack of acknowledgments for 90% of packets will bring the transmission to a near-halt as the regulated content traffic burst will be followed by a corresponding burst of unacknowledged packet retransmissions, thereby reducing content/packet throughput dramatically and unnecessarily.

A second shortcoming of classic leaky bucket rate regulation is that it does not take into consideration packet processing priorities. Making reference again to the preceding example, when more than 90% of packets are discarded during a long burst, the traffic class associations of the dropped packets are not reflected in the regulatory action therefore leading to inadequate quality of service. When classic leaky bucket rate regulation is employed on egress, the temporary cessation of packet transmission may result in unacceptable latency being incurred by high priority packets.

Current hardware designs for rate control which provide traffic class differentiation, suffer from implementation complexities. Typically, such designs call for employing a separate classic leaky bucket for every traffic flow group to be regulated—one per port per class, or even one per content flow. The combinatorial complexity of such a brute force implementation is staggering. Huge amounts of parallelism are therefore required, because many hardware state machines must be simultaneously responsible for periodically adding tokens to each bucket. Alternatively, fewer state machines can actually be employed, but then each one must handle a subset of the total number of buckets putting stringent constraints on processing timing.

Providing one classical leaky bucket per port, per traffic class in hardware does not only lead to high gate count implementations, but is also overly restrictive. Often an operator turning up users 106 (subscribers) does not know how to apportion the negotiated bandwidth among multiple traffic classes or micro-flows per user, making the abundance of parameters to be programmed tedious. Furthermore, even if bandwidth apportionments may be reasonably known, these apportionments may rapidly change over time leading to a huge configuration overhead. For example, suppose that user 106 negotiates 10 Mbps for each one of three traffic classes 0, 1, and 2. Rate regulation employing three classic leaky buckets does not allow for the possibility that the user 106 will want to send a combined 30 Mbps in some other ratio on a later occasion, therefore resulting in packets being unnecessarily dropped because of a lack of flexibility.

At the input port 110, the traffic classes are typically only significant locally for the purpose of defining different levels of service. Therefore, there should be no reason to block the user's 106 transmission because it does not fit the specific class apportionments even though the total 30 Mbps bandwidth paid for is not exhausted.

The research in the field of traffic metering includes Request For Comments (RFC 2698) “A Two Rate Three Color Marker”, incorporated herein by reference. In accordance with the RFC 2698 standard, classified packets of a particular flow are tracked as the packets traverse a network node and marked at ingress with one of three “colors” using the status of two ingress leaky buckets associated with the flow. At egress, after the packets have traversed the network node, the packets. may be discarded if the link is congested. Dropping packets is based in part on the colors with which the packets have been marked. However, aside from the complex multi-bucket implementation taught, if the teachings of RFC2698 were used in addressing rate control in respect of a up-link and a down-link between an edge network node and a network access device, complex issues relating to packet traversal across the edge network node would complicate implementation preventing hardware implementations as packet color marking and packet discard based on color is to be performed respectively on typically separate input hardware and output hardware.

A prior art U.S. Pat. No. 6,167,027 entitled “Flow Control Technique for X.25 Traffic in a High Speed Packet Switching Network,” which issued on Dec. 26, 2000 to Aubert et al. describes a preventive X.25 flow control mechanism: Each access node in a network includes a leaky bucket component. Each time an incoming packet is received by the leaky bucket component, the number of available tokens is compared to two predetermined threshold values. If the number of available tokens is less than the low threshold, acknowledgements of received packets are stopped, inducing an interruption of packets transmitted by the emitting attached X.25 terminals. Interrupting packet transmission will lead to regeneration of the number of tokens in the token pool as previously received packets are processed through. If the number of tokens reaches the high threshold, acknowledgements are again generated to restore packet transmissions. The two thresholds essentially serve the role of warning of “bucket empty” and “bucket full” conditions. Although the solution is inventive, it suffers from the above mentioned shortcomings of the classic leaky bucket in that: especially in a X.25 environment, unacknowledged packets arriving at high rates will certainly be followed by corresponding packet retransmissions at high rates; and traffic class associations are not taken into consideration in effecting the proposed flow control.

Prior art United States Patent Application entitled “Method and apparatus for guaranteeing data transfer rates and enforcing conformance with traffic profiles in a packet network.” which was published under number 20020036984A1 on Mar. 28, 2002 by Chiussi et al. describes conformance enforcement to traffic profiles using two leaky buckets per flow. Although inventive, as mentioned above, employing two leaky buckets is considered unnecessarily complex.

Prior art United States Patent Application entitled “Gigabit Switch with Fast Filtering Processor” and published under number 20020012585A1 on Jan. 31, 2002 by Klakunte et al. describes traffic content tracking via a classical leaky bucket for traffic shaping purposes in switching packets. Although inventive, a complex prior determination regarding whether packets are in-profile or out-of-profile is necessary in removing tokens from and adding tokes to the classical leaky bucket.

A port based implementation, conducive to hardware implementation, is sought addressing issues of a services provisioning model in which users fully benefit from the bandwidth subscribed to. There is, therefore, a requirement to overcome the aforementioned limitations.

### SUMMARY OF THE INVENTION

In accordance with an aspect of the invention, an egress rate controller monitoring content traffic transmitted from an edge network node of a packet-switched communications network node is provided. The egress rate controller includes a leaky bucket having an initial maximum number of tokens which decreases as packets are received in an associated output buffer at a reception token rate for transmission. A plurality of token availability threshold level registers specify a corresponding plurality of token amounts defining token availability regions. And, a packet transmission suppression controller selectively suppresses transmission of a packet having a traffic class association based on a current token availability level being within a token availability region specifying transmission suppression of packets of the traffic class.

In accordance with another aspect of the invention, an ingress rate controller monitoring content traffic received at an edge network node of a packet-switched communications network node is provided. The ingress rate controller includes a leaky bucket having an initial maximum number of tokens which decreases as packets received at a reception token rate are accepted. A plurality of token availability threshold level registers specify a corresponding plurality of token amounts defining token availability regions. A plurality of packet discard probability registers, each packet discard probability register specifies a probability with which packets of a specific traffic class are to be dropped when a current token availability level is within a token availability region. And, a packet acceptance controller selectively randomly discarding packets having a traffic class association based on the current token availability level being within a token availability region specifying random packet discard of packets of the traffic class.

In accordance with a further aspect of the invention, a method of effecting egress rate control is provided. The method includes. selectively suppressing packet transmission for a packet of a particular traffic class when a current token availability level of a leaky bucket tracking packet transmissions is between two token availability threshold levels of a plurality of token availability threshold levels.

In accordance with yet another aspect of the invention, a method of effecting ingress rate control is provided. The method includes random discarding packets of a particular traffic class when a current token availability level of a leaky bucket tracking packets is between two token availability threshold levels of a plurality of token availability threshold levels.

The advantages are derived from multiple thresholds being associated with a single leaky bucket per traffic flow direction enabling the rate control mechanism to selectively control traffic rates based on a traffic class criteria.

### BRIEF DESCRIPTION OF THE DRAWINGS

The features and advantages of the invention will become more apparent from the following detailed description of the exemplary embodiments with reference to the attached diagrams wherein:

FIG. 1 is a schematic diagram showing, in accordance with an exemplary embodiment of the invention, cooperating elements providing rate controlled content exchange between a network access device and communications network edge equipment;

FIG. 2 is a schematic diagram showing, in accordance with the exemplary embodiment of the invention, three egress rate control scenarios for traffic content conveyed via a user output port of an edge network node; and

FIG. 3 is a schematic diagram showing, in accordance with the exemplary embodiment of the invention, three ingress rate control scenarios for traffic content conveyed via a user input port of an edge network node.

It will be noted that in the attached diagrams like features bear similar labels.

### DETAILED DESCRIPTION OF THE EXEMPLARY EMBODIMENTS

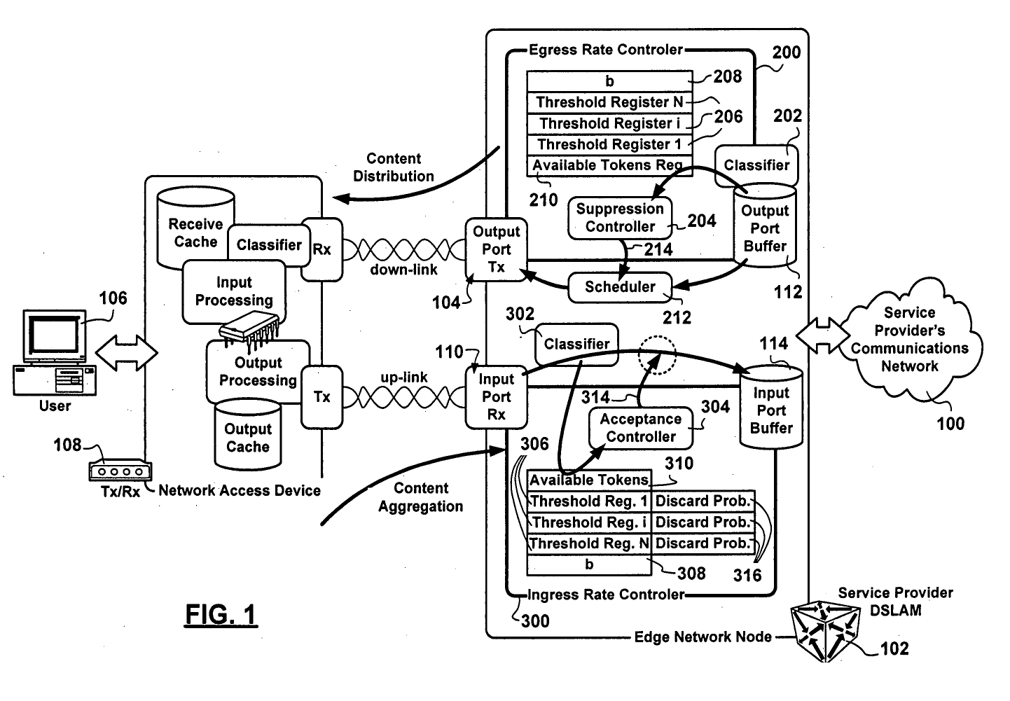

Making reference to FIG. 1, in accordance with an exemplary embodiment of the invention, an egress rate controller 200 includes: a packet classification module 202, a suppression controller 204, multiple token availability threshold registers 206, a bucket size register 208, and a current token availability register 210.

In accordance with the exemplary embodiment of the invention, a single leaky bucket is employed per output port 104 in effecting egress rate control in respect of all content conveyed via the output port 104. The bucket size register 208 holds a value “b” representative of the maximum number of tokens allocated to the bucket in implementing egress rate control at the output port 104.

It is pointed out that the size b of the leaky bucket employed in egress rate control, when multiplied by the size of each token, is at most equal to the size of the output port buffer 212. The value b may be set externally and/or set to a specified value during edge network node 102 startup. By employing an output port buffer 112 larger than the leaky bucket, packet transmission over the down-link may be suppressed without discarding packets.

On startup, the value of the current token availability register 210 is set to b. After storing, in the output port buffer 112, a packet to be conveyed via the output port 104, in scheduling the packet for transmission, if the number of tokens required to store the packet in the output port buffer 112 is less than the value the current token availability register 210, the value of the current token availability register 210 is decremented by that number of tokens. Packets are transmitted over the down-link via the output port 104 when ever the down-link is idle and a packet is available in the output port buffer 112. The value of the current token availability register 210 is incremented at the down-link negotiated rate r as the available tokens in the bucket are periodically replenished.

In accordance with the exemplary embodiment of the invention, egress rate control at the edge network node 102 takes in to account the fact that the packets have traversed the entire network from remote sources and dropping packets so close to the destination user node 106 would incur a large transport overhead in the communications network 100. Therefore egress rate control, assuming availability of ample storage 112 at the edge network node 102 would best be enforced via packet forwarding suppression as opposed to dropping packets. The following question arises: if the packets have survived the long haul transmission, why burden the edge network node 102 and not just transmit the packets over the down-link to reduce storage resource utilization at the edge network node 102. While it would make sense from a storage resource utilization perspective to empty the output buffer 112 as fast as possible, using more bandwidth than negotiated, and paid for, also induces crosstalk in adjacent down-links and up-links servicing other users 106 degrading services provisioned to the other users 106.

It is important to re-emphasize that what is suppressed is packet transmission over the down-link with the intent that the packets will be transmitted at a later time. Therefore, the suppression controller 204 will provide its suppression signal 214 to a scheduler 212. As the scheduler 212 services the output port 104 on average at the down-link negotiated service rate r, tokens are added to the bucket, on average, at the down-link negotiated service rate r.

N threshold registers 206 are populated, during edge network node 102 startup and/or by re-configuration, with leaky bucket token availability level values. In accordance with the exemplary embodiment of the invention, the N threshold register values define token availability regions, corresponding to an engineered response to bandwidth utilization in respect of packet traffic classes supported at the edge network node 102. The values of the threshold registers 206 may be specified in terms of tokens or percentages of the bucket size b. Actual threshold register values are expressed in tokens. As the number of traffic classes supported by the edge network node 102 is known in designing the edge network node, default threshold register values may be provided during deployment minimizing configuration overheads.

The packet classifier 202 classifies packets in accordance with M traffic classes supported by the edge network node 102. In accordance with the exemplary embodiment of the invention, egress rate control is effected by the suppression controller 204, based on the value of the current token availability register 210 compared against the values of the N threshold registers 206, in respect of packets of specific class associativity.

In accordance with a two threshold registers (N, 1) implementation the following combined egress rate control behavior is provided:

| Current token availability | Egress control behavior |
|---|---|
| Greater than Threshold(N) tokens | Allow all traffic |
| Between Threshold(N) and | Suppress lowest priority traffic |
| Threshold(1) tokens | |
| Less than Threshold(1) tokens, | Suppress all traffic except |
| but enough tokens | highest priority traffic |
| Insufficiently many tokens | Suppress all traffic |

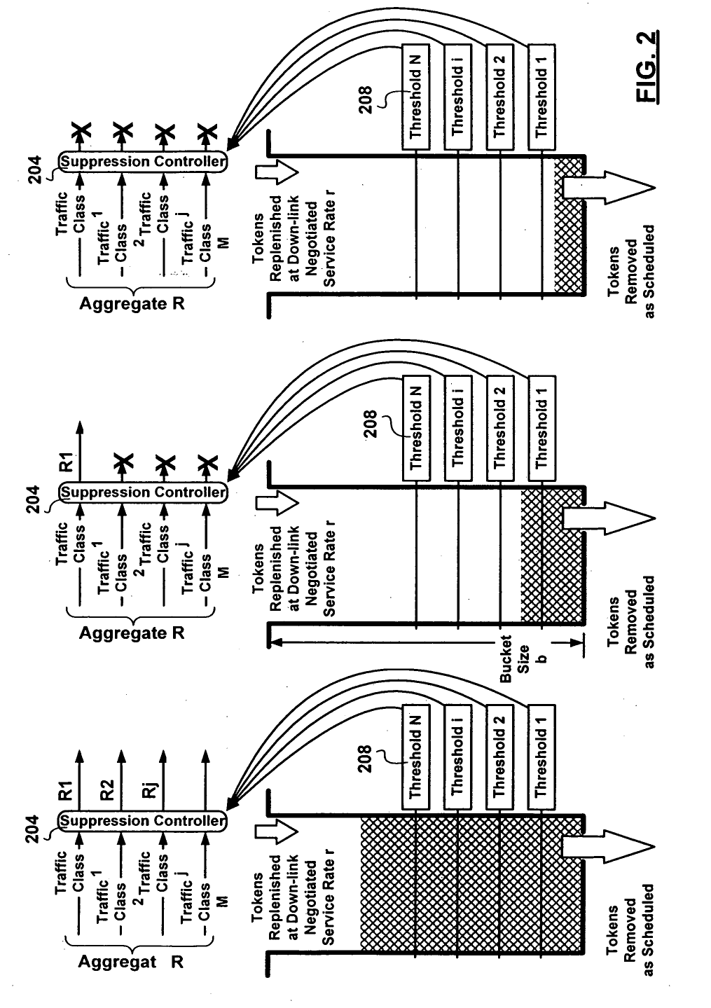

irrespective of the number M of traffic classes supported by the edge network node 102. FIG. 2 shows three exemplary egress rate control scenarios in respect of a generic implementation.

In accordance with the exemplary embodiment of the invention, the use of multiple token availability thresholds in respect of a single leaky bucket, the egress rate control provided enables selectively halting the scheduling of lower priority traffic classes for transmission as the bucket is depleted of tokens. Also, any single class of packets conveyed may utilize the entire negotiated bandwidth r of the down-link, as long as the aggregate traffic requires less than (or is equal to) the negotiated bandwidth r.

Depending on the scheduling algorithm employed by the scheduler 212 in servicing output port buffer 112, there may exist side effects associated with the temporary cessation of scheduling packets of one or more traffic classes for transmission. Although such issues are outside the scope of the present disclosure, it is important for the designer/operator to carefully consider the impact of egress rate control on particular scheduling implementations. Real-time traffic with strict latency bounds, such as, but not limited to, voice-over-packet implementations, will benefit the most from the presented approach, as packets associated with other traffic classes are delayed (suppressed) in favor thereof.

In accordance with the exemplary embodiment of the invention, in combining traffic class differentiation and leaky-bucket-type control in effecting egress rate control, quality-of-service may be an adequately assured by distinguishing among packets having different traffic class associations in a simple and flexible manner.

Making reference to FIG. 1, in accordance with the exemplary embodiment of the invention, an ingress rate controller 300 includes: a packet classifier module 302, an acceptance controller 304, multiple token availability threshold registers. 306 and corresponding multiple discard probability registers 316, a bucket size register 308, and a current token availability register 310.

In accordance with the exemplary embodiment of the invention, a single leaky bucket is employed per input port 110 in effecting ingress rate control in respect of all content conveyed via the input port 110. The bucket size register 308 holds a value b representative of the maximum number of tokens allocated to the bucket in implementing ingress rate control at the input port 110.

It is pointed out that the size b of the leaky bucket employed in ingress rate control, when multiplied by the size of each token, is at most equal to the size of the input port buffer 114. The value b may be set externally and/or set to a specified value during edge network node 102 startup. By employing an input port buffer 112 larger than the leaky bucket, a slack may be provided in the number of packets being conveyed to mask effects of the packet ingress rate control over the up-link with the intent to minimize packet retransmission effects associated with packet discard instances.

On startup, the value of the current token availability register 310 is set to b. In receiving a packet via the input port 110, if the number of tokens required to store the packet in the input port buffer 114 is less than the value of the current token availability register 310, the value of the current token availability register 310 is decremented by that number of tokens. A system scheduler employed in servicing the input port 110 is expected, on average, to service the input port 110 at the up-link negotiated service rate r, therefore tokens are added to the bucket, on average, at the up-link negotiated service rate r.

In accordance with the exemplary embodiment of the invention, ingress rate control at the edge network node 102 takes into account the fact that the packets have only traveled a single hop from the network access device 108, and therefore discarding packets in effecting ingress rate control only incurs a relatively low packet transport overhead in the communications network.

It is important to re-emphasize that discarded packets will be re-transmitted at a later time by the user's network node 106 (or the network access device 108). The user network node 106 will typically wait for a predetermined period of time before re-transmitting. Discarding a large number of packets in a large burst will lead, to an immediate packet unavailability for transmission during the predetermined wait time period followed by a subsequent burst of packets after the expiration of the wait time period. Providing a slack in the number of packets conveyed may alleviate the absence of packets during the predetermined wait time period while introducing an overall delay, but will not prevent the subsequent burst.

In accordance with the exemplary embodiment of the invention, an early packet discard discipline favoring higher priority packet traffic classes is employed in implementing ingress rate control as tokens in the bucket are being depleted.

N threshold registers 306 are populated, during edge network node 102 startup and/or by re-configuration, with leaky bucket token availability level values. In accordance with the exemplary embodiment of the invention, the N threshold register values define token availability regions corresponding to an engineered response to bandwidth utilization in respect of packet traffic classes supported at the edge network node 102. The values of the threshold registers 306 may be specified in terms of tokens or percentages of the bucket size b. Actual threshold register values are expressed in tokens. As the number of traffic classes supported by the edge network node 102 is known in designing the edge network node, default threshold register values may be provided minimizing configuration during deployment.

N discard probability registers 316 are populated, during edge network node 102 startup and/or by re-configuration, with discard probability values corresponding to the token availability regions. As the number of traffic classes supported by the edge network node 102 is known in designing the edge network node, default discard probability register values may be provided during deployment minimizing configuration overheads.

The packet classifier 302 classifies packets in accordance with M traffic classes supported by the edge network node 102. In accordance with the exemplary embodiment of the invention, ingress rate control is effected by the acceptance controller 304, based on the value of the current token availability register 310 compared against the values of the N threshold registers 306, in- respect of packets of specific class associativity. Actual packets of a particular traffic class are randomly discarded with the discard probability specified in the corresponding discard probability register 316.

In accordance with a two threshold registers (N, 1) and two discard probability registers implementation the following combined ingress rate control behavior is provided:

| Current token availability | Ingress control behavior |
|---|---|
| Greater than Threshold(N) | Accept all traffic |
| tokens | |
| Between Threshold(N) and | Drop lowest priority traffic class packets |
| Threshold(1) tokens | with corresponding specified probability. |
| | Drop no other traffic. |
| Less than Threshold(1) | Drop all lowest priority traffic class packets. |
| tokens, but enough tokens | Drop no highest priority traffic class packets. |
| | Drop all other traffic with corresponding |
| | specified probability. |
| Insufficiently many tokens | Drop all traffic. |

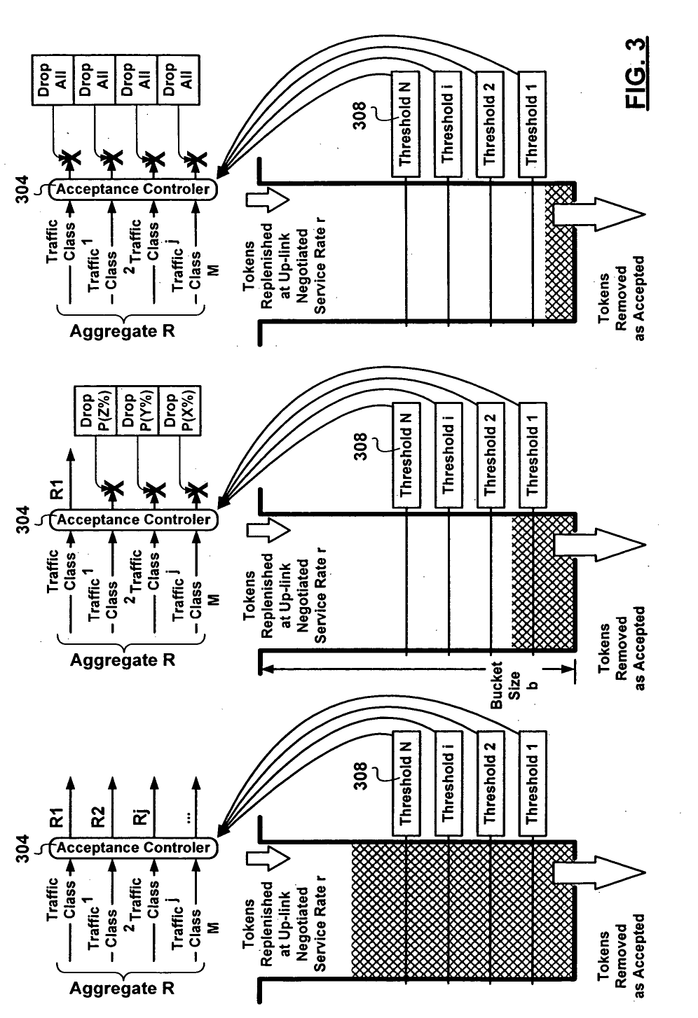

irrespective of the number M of traffic classes supported by the edge network node 102. FIG. 3 shows three exemplary ingress rate control scenarios in respect of a generic implementation.

The ingress rate control method presented provides highest traffic priority class packets with something much like a reserved token pool even as the service provider ensures that no extra resources are utilized. The randomness of the probabilistic packet discard further improves TCP performance.

Packets may be dropped at the ingress for reasons other than ingress rate control: for example, packet storage resource insufficiency in the edge network node 102 downstream from the input port 110. It is critical that tokens not be removed from the bucket unless the packet is ultimately forwarded. In implementation, this may require a central overseer of packet discard which would take as an input the acceptance control signal 314.

In accordance with the exemplary embodiment of the invention, in combining the multiple token availability thresholds and random early discard with leaky bucket, with random packet discard in effecting ingress rate control as tokens in the bucket are depleted, a more graceful back-off for TCP transmissions is ensured during a large burst of packets.

In accordance with another exemplary embodiment of the invention, packet discard at the ingress of a network access device 108 using leaky bucket regulation may be employed. The approach can be applied in products developed for an economic model in which a user 106 is allowed to be greedy, but the service provider adheres to a Service Level Agreement (SLA) guaranteeing bandwidth to the user 106 no better and no worse than an agreed upon level. Such products include MultiDwelling Units (MDU) employed by a multitude of users 106 to access a service provider's network 100.

Therefore the present invention provides a mechanism for ingress and egress rate control in packet network nodes providing quality of service support.

The embodiments presented are exemplary only and persons skilled in the art would appreciate that variations to the above described embodiments may be made without departing from the spirit of the invention. The scope of the invention is solely defined by the appended claims.

We claim:

1. An egress rate controller monitoring content traffic transmitted from an edge network node of a packet-switched communications network node comprising:
a. a leaky bucket having an initial maximum number of tokens which decreases as packets are received in an associated output buffer at a reception token rate for transmission;
b. a plurality of token availability threshold level registers specifying a corresponding plurality of token amounts defining token availability regions; and
c. a packet transmission suppression controller selectively suppressing transmission of a packet having a traffic class association based on a current token availability level being within a token availability region specifying transmission suppression of packets of the traffic class.

2. The egress rate controller claimed in claim 1, further comprising a classifier classifying received packets in accordance with a plurality of traffic classes.

3. The egress rate controller claimed in claim 1, further comprising a scheduler delaying packet transmission scheduling in accordance with a packet transmission suppression signal provided by the packet transmission suppression controller.

4. The egress rate controller claimed in claim 1, further comprising a bucket size register holding a value representative of a maximum number of tokens allocated to the leaky bucket.

5. The egress rate controller claimed in claim 4, further comprising an output buffer, the size of the leaky bucket, in tokens, being at most equal to the size of output buffer, employing an output buffer larger than the leaky bucket enabling suppression of packet transmission without discarding packets.

6. The egress rate controller claimed in claim 1, wherein the egress rate controller is associated with an output port of the edge network node.

7. An communication network node comprising at least one ingress rate controller claimed in claim 1.

8. An communication network node comprising at least one ingress rate controller claimed in claim 1 associated with at least one output port thereof.

9. An ingress rate controller monitoring content traffic received at an edge network node of a packet-switched communications network node comprising:
a. a leaky bucket having an initial maximum number of tokens which decreases as packets received at a reception token rate are accepted;
b. a plurality of token availability threshold level registers specifying a corresponding plurality of token amounts defining token availability regions;
c. a plurality of packet discard probability registers, each packet discard probability register specifying a probability with which packets of a specific traffic class are to be dropped when a current token availability level is within a token availability region, and
d. a packet acceptance controller selectively randomly discarding packets having a traffic class association based on the current token availability level being within a token availability region specifying random packet discard of packets of the traffic class.

10. The ingress rate controller claimed in claim 9, further comprising a classifier classifying received packets in accordance with a plurality of traffic classes.

11. The ingress rate controller claimed in claim 9, further comprising a bucket size register holding a value representative of a maximum number of tokens allocated to the leaky bucket.

12. The ingress rate controller claimed in claim 9, further comprising an input buffer, the size of the leaky bucket, in tokens, being at most equal to the size of input buffer, employing an input buffer larger than the leaky bucket providing a slack in the number of packets available for transmission to mask the effects of the ingress rate control effected.

13. The ingress rate controller claimed in claim 9, wherein the ingress rate controller is associated with an input port of the edge network node.

14. An communication network node comprising at least one ingress rate controller claimed in claim 9.

15. An communication network node comprising at least one ingress rate controller claimed in claim 9 associated with at least one input port thereof.

16. A method of effecting egress rate control comprising the step of: selectively suppressing packet transmission for a packet of a particular traffic class when a current token availability level of a leaky bucket tracking packet transmissions is between two token availability threshold levels of a plurality of token availability threshold levels.

17. The method of effecting egress rate control as claimed in claim 16, wherein selectively suppressing packet transmission, the method further comprises a step of: selectively suppressing packet transmission scheduling.

18. The method of effecting egress rate control as claimed in claim 17, further comprising a step of: rescheduling the packet for transmission.

19. The method of effecting egress rate control as claimed in claim 16, further comprising a prior step of: classifying packets in accordance with a plurality of traffic classes.

20. The method of effecting egress rate control as claimed in claim 16, further comprising a step of:
a. determining whether a plurality of tokens corresponding to a size of the packet are available in the leaky bucket; and
b. selectively suppressing packet transmission if there are insufficiently many tokens available in the leaky bucket.

21. The method of effecting egress rate control as claimed in claim 20, wherein selectively suppressing packet transmission, the method further comprises a step of: selectively suppressing packet transmission scheduling.

22. The method of effecting egress rate control as claimed in claim 21, further comprising a step of: storing the packet in an output buffer.

23. The method of effecting egress rate control as claimed in claim 21, further comprising a step of: rescheduling the packet for transmission.

24. A method, of effecting ingress rate control comprising the step of: selectively randomly discarding packets of a particular traffic class when a current token availability level of a leaky bucket tracking packets is between two token availability threshold levels of a plurality of token availability threshold levels.

25. The method of effecting ingress rate control as claimed in claim 24, wherein randomly discarding packets the method further comprises a step of: randomly discarding packets with a corresponding discard probability.

26. The method of effecting ingress rate control as claimed in claim 24, further comprising a prior step of: classifying packets in accordance with a plurality of traffic classes.

27. The method of effecting ingress rate control as claimed in claim 24, further comprising a step of:
a. determining whether a plurality of tokens corresponding to a size of the packet are available in the leaky bucket; and
b. selectively discarding the packet if there are insufficiently many tokens available in the leaky bucket.
